(19) United States
(12) Patent Application Publication
(10) Pub. No.: US 2005/0075243 A1
(43) Pub. Date: Apr. 7, 2005

(54) Catalyst for dehydrogenation of hydrocarbons

(75) Inventors: Vladimir Fridman, Louisville, KY (US); Andrzej Rokicki, Prospect, KY (US)

Correspondence Address: Scott R. Cox;LYNCH, COX, GILMAN & MAHAN, PSC., Suite 2200, 400 West Market Street, Louisville, KY, 40202, US

(73) Assignee: Sud-Chemie, Inc., Louisville, KY (US)

(21) Appl. No.: 10/680,544

(22) Filed: Oct. 7, 2003

(51) Int. Cl. B01J 23/26

(52) U.S. Cl. 502/306

(57) ABSTRACT

A stationary or fluid bed dehydrogenation catalyst containing an alumina carrier, with chromium, zirconium, magnesium and, preferably, an alkali metal added as promoters. The resultant catalyst demonstrates greater selectivity and olefin yield than prior art dehydrogenation catalysts containing aluminum and chromium only.

### BACKGROUND

The present invention relates to a catalyst for stationary and/or fluid bed dehydrogenation processes for hydrocarbons, which is particularly useful in vapor phase dehydrogenation. The catalyst comprises a chromium oxide on alumina catalyst, with at least two promoters including at least zirconium and magnesium, and preferably, an alkali metal. The resultant catalyst exhibits higher selectivity after aging than prior art catalysts.

Catalysts are used in a variety of commercial reactions, and are typically present in the form of a pellet or powder having metal active sites on or within an essentially chemically inert material carrier. In many catalytic processes, a chemical reactant contained in a gas stream is passed over or through a bed containing the catalyst. The reactant contacts the active site on the catalyst, a chemical conversion occurs to generate one or more products, and those products are released from the catalyst's active site. For commercial operations, it is desirable that the gas stream be passed over the catalyst bed at an essentially constant and rapid rate.

In the production of olefins and diolefins by catalytic dehydrogenation, it is desirable to obtain as high a yield of olefins or diolefins as possible with a single passage of the material to be catalyzed through the dehydrogenation zone. It is also important to produce as small an amount of by-products and coke during the dehydrogenation process as is possible.

Selectivity plays an important role in olefin production. As the annual production of olefins (such as isobutylene, propylene and butadiene) by catalytic dehydrogenation is at least 3 million tons, even relatively small increases in selectivity of the catalyst at constant temperature, as small as a fraction of a percentage point, can be very beneficial for olefin producers.

Processes utilizing chrome-alumina catalysts for the conversion of paraffinic and olefinic hydrocarbons are well known and have been described in technical literature as well as in numerous patents starting in the 1940's. Typical catalysts used for dehydrogenation of paraffins and olefins, as disclosed, for example, in U.S. Pat. Nos. 2,399,678 and 2,423,029, contain chromium oxide on the surface of an aluminum oxide carrier. Dehydrogenation catalysts according to U.S. Pat. No. 2,945,823 also contain small amounts of sodium bentonite.

U.S. Pat. No. 2,956,030 discloses dehydrogenation catalysts that have been prepared by impregnating a stabilized, porous, high surface area alumina, which comprises predominantly gamma-type alumina, with an aqueous chromium trioxide solution or with a solution of a chromium compound that can be converted to an oxide. The alkali metal content of this catalyst is controlled within a well-defined range of about 0.15 to about 0.5% alkali metal oxide by weight of the catalyst.

Other examples of chromia-alumina catalysts which are recognized as effective catalysts for dehydrogenation are disclosed by U.S. Pat. No. 3,488,402, which teaches the use of catalysts that comprise “alumina, magnesia, or a combination thereof, promoted with up to about 40% of an oxide of a metal” of Group 4, Group 5 or Group 6. (The terms “Group 4”, “Group 5” and “Group 6” refer to the new IUPAC format numbers for the Periodic Table of the Elements. Alternative terminology, known in the art, includes the old IUPAC labels “Group IVA,” “Group VA” and “Group VIA”, respectively, and the Chemical Abstract Services version of numbering as “Group IVB,” “Group VB” and “Group VIB”, respectively.) The '402 patent discloses specific examples of such catalysts including “alumina promoted with about 40% of any of chromium oxide, zirconium oxide and titanium oxide”, and notes that “a particularly effective catalytic composition for dehydrogenating paraffinic hydrocarbons is a catalyst consisting of about 40% chromia and 60% alumina . . . ” The '402 patent, however, does not teach a three additive catalyst.

A number of attempts to improve the quality of alumina-chromium catalyst have been made. One method focuses on improvements in the stability of the alumina-chromium catalyst. U.S. Pat. No. 2,374,404 discloses a dehydrogenation catalyst for use with paraffins and olefins at high temperature, comprising alumina and chromium oxide and from 1-15% zirconium oxide.

Another alumina-chromium catalyst for the dehydrogenation of paraffinic compounds to olefins and diolefins is disclosed in U.S. Pat. No. 2,375,402. This catalyst is promoted with minor amounts of magnesia that makes the catalyst more stable at high temperatures over a relatively long period of time. However, no selectivity improvement for the catalyst after promotion with magnesia is suggested.

A dehydrogenation catalyst, which maintains high activity along with low coke formation during the reaction, is described in U.S. Pat. No. 5,378,350. This catalyst comprises aluminum, chromium and zirconium oxides with minor amounts of cesium.

Another catalyst designed to improve the activity of this reaction is disclosed in CN Patent Number 1185994A. These catalysts have an AaBbCcDd composition where: A=Cr, Pt or V; B═La, Cu, Be, Ag, Mg, Ca, Ba, Zr, Sn and Fe; C═Li, Na, K and D=Al, Si, Ti, Zr. The addition of these promoters to aluminum and chromium oxides makes the catalysts more active. Although this patent discloses numerous options for additives, there is no indication of the simultaneous use of Zr and Mg as promoters.

Catalysts useful for the catalytic dehydrogenation of high molecular weight paraffins to corresponding olefins are disclosed in U.S. Pat. No. 3,322,849. These catalysts contain 30 to 50 weight percent of chromium oxide, 5 to 15 weight percent of cupric oxide, and 10 to 35 weight percent of manganese dioxide. Preferably, the support for the catalysts comprises alumina, magnesia, or silica.

In U.S. Pat. No. 3,719,721 the promotion on an alumina-chromium catalyst with niobium and tantalum to increase the conversion of paraffins and the selectivity of the catalyst is described.

WO 01/68244 A2 discloses a catalyst composition having the formula CraAbBc(O₁-z(OH)₂) y wherein a+b+c=1; wherein A is an element selected from the group consisting of Zn, Sn, Rh, Li, Na, K, Rb, Cs, Be, Mg, Ca, Sr and Ba; B is at least one element selected from group consisting of Al, Si and Mg; a is greater than 0.01 but less than 0.5; b is greater than 0.01 but less than or equal to 0.5; c is greater than 0.2 but less than or equal to 0.999; y is determined by the sum of the oxidation states of Cr, A and B individually multiplied by the corresponding stoichiometric coefficients a, b or c, said sum then divided by 2; and z is greater than or equal to 0 but less than or equal to 2. This patent discloses the use of magnesium as a promoter, but it does not disclose the use of zirconium.

It is one object of the invention to produce a useful dehydrogenation catalyst comprising chromium distributed on an alumina carrier, which is promoted with zirconium and magnesium and preferably an alkali metal. These promoters provide enhanced performance for the catalyst over prior art dehydrogenation catalysts.

### SUMMARY OF THE INVENTION

The present invention relates to a stationary or fluid bed dehydrogenation catalyst comprising a carrier combined with chromium, zirconium, magnesium and alkali metal promoters. In the preferred process of preparation of the catalyst, the carrier is spray-dried or pelletized, dried, calcined and impregnated with a CrO₃ solution which includes the promoters. The resultant dehydrogenation catalyst demonstrates higher selectivity after aging than prior art catalysts comprising alumina and chromium alone.

### DETAILED DESCRIPTION OF THE PREFERRED EMBODIMENT

The catalyst of the present invention is intended for use in a stationary and/or fluid bed dehydrogenation process for converting C₂-C₆ hydrocarbons to olefins and/or diolefins. Dehydrogenation reactions are normally conducted at the highest practical throughput rates which produce an optimum yield. Yield is dependent upon conversion and selectivity of the catalyst. These characteristics determine the efficiency of the process. Selectivity of the catalyst is defined as the proportion of the desired product, e.g. propylene, isobutylene or higher molecular weight olefin corresponding to the total initial paraffin converted. Activity or conversion refers to that portion of feedstock that is converted to the desired product and by-products. For high efficiency of the process, it is also important to have both a high initial yield with fresh catalyst and also high activity of the catalyst after aging. Both of these criteria (initial activity and activity after aging) are used to estimate the catalyst's efficiency.

The dehydrogenation catalyst of the present invention can be utilized in either a fluid bed or a stationary bed reactor. These reactors are well known in the art.

As is known in the art, a catalyst generally has one or more active metals dispersed on, or compounded with, a carrier or support to act as a promoter. The support provides a means for increasing the surface area of the catalyst. Recommended carriers for the dehydrogenation catalysts of the invention include aluminum oxide, aluminas, such as gamma, eta, or delta alumina or mixtures thereof, alumina monohydrate, alumina trihydrate, such as bayerite, nordstrandite, or gibbsite or mixtures thereof, alumina-silica, transition aluminas, silica, silicates, zeolites and combinations thereof. Preferably the carrier is formed from bayerite or eta alumina. The carrier can be formed as a powder or in the shape of rings, pellets, tablets or extrudates. The catalyst of the present invention preferably has a surface area of from about 15 m²/g to about 300 m²/g, a pore volume of from about 0.2 cc/g to about 1.5 cc/g, preferably 0.25 cc/g to about 0.35 cc/g, and an average pore diameter of from about 3 nm to about 30 nm. If the catalyst is for use in a fluid bed, the catalyst further preferably has a particle size of from about 20 μm to about 150 μm. The carrier may be prepared by a variety of techniques that are known in the art. Preferably, the carrier is spray-dried or pelletized and calcined at a temperature from about 500° C. to about 1100° C.

Chromium is commonly used as an active phase in dehydrogenation catalysts because of its efficiency in paraffin dehydrogenation reactions. Typically in dehydrogenation catalysts, the chromium is in the form of Cr₂O₃ that is produced from CrO₃. The chromium may also be derived from other inorganic chromium salts, such as ammonium chromate or dichromate or chromium nitrate or other organic chromium salts or mixtures thereof. The catalyst of the present invention preferably comprises from about 10 wt % to about 30 wt % chromium in the form of Cr₂O₃, based on the total catalyst weight, including the Cr₂O₃. In a more preferred embodiment, the catalyst comprises from about 15 wt % to about 28 wt % chromium, and in a most preferred embodiment, the amount of chromium is from about 17 wt % to about 24 wt %, by weight. The application of chromium to the support material can take place by any process well known in the art, e.g. by simultaneous precipitation of aluminum oxide and chromium oxide from an aqueous solution containing aluminum and chromium salts, by simultaneous impregnation of all compounds, by treating an alumina support with a solution of chromic acid or by mixing chromium oxide with aluminum hydroxide or oxide.

In addition to a chromium promoter, an alkali metal promoter is preferably present in the catalyst of the invention. Many of the alumina trihydrates and other alumina hydrates which are used as the starting material for the carrier are prepared by methods that result in greater or lesser quantities of alkali metal compounds being present. Thus, alkali metal compounds in quantities from about 0.3 to about 2 wt. % may be present in the carrier, as produced.

If an alkali metal compound is not present in quantities within the specified range in the carrier, its content can be adjusted by adding an additional quantity of an alkali metal hydroxide, oxide, or salt during addition of the chromium promoter to the carrier. Alternatively, the alkali metal content can be increased by the addition of sufficient quantities of an alkali metal chromate to the chromium solution when the chromium promoter is impregnated onto the carrier. The preferred alkali metal compounds are sodium and potassium oxide, most preferably sodium oxide. The preferred quantity of sodium oxide is from about 0.3 to about 2 wt. %, most preferably from 0.3 to 1 wt %, based on the total weight of the catalyst, including the Na₂O. Corresponding quantities of other alkali metal compounds may be used in combination with, or in addition to the sodium oxide, with the weight percentage to be added, adjusted based on the molecular weight of the alkali metal compound that is added.

Dehydrogenation catalysts containing chromium also commonly contain one or more additional promoters that are added to improve selected properties of the catalyst or to modify the catalyst activity and/or selectivity. In the present invention, zirconium is added to the catalyst as a promoter. The zirconium cation may be present in a variety of forms and from different zirconium sources, such as, ZrO₂, zirconium hydroxide, a zirconium basic carbonate or a similar zirconium-containing compound or mixtures thereof. The zirconium compound, calculated as ZrO₂, preferably comprises from about 0.1 wt % to about 15 wt % zirconium, based on the total catalyst weight, including the ZrO₂. In a more preferred embodiment, the catalyst comprises from about 0.1 wt % to about 5 wt % zirconium; and in a most preferred embodiment, the amount of zirconium is from about 0.5 wt % to about 1.5 wt %. The zirconium may be added to the catalyst in a variety of methods, as are known in the art. In a preferred embodiment the zirconium is co-impregnated with the chromium.

Magnesium is also added to the catalyst as a promoter. The magnesium compound, calculated as magnesium oxide, comprises from about 0.1 to about 15 weight percent magnesium, based on the total catalyst weight, including the magnesium oxide. In a more preferred embodiment the catalyst comprises from about 0.1 to about 2 weight percent magnesium, and in a most preferred embodiment the amount of magnesium is from about 0.5 to about 1 weight percent. The magnesium may be added to the catalyst in a variety of methods as are known in the art. In a preferred embodiment the magnesium is co-impregnated with chromium.

In a preferred process for production of the catalyst, alumina pellets are prepared from alumina trihydrate, such as bayerite, gibbsite, or nordstrandite or mixtures thereof, preferably bayerite, or other such alumina hydrates and aqueous nitric acid. The alumina is preferably in the form of gamma-, delta-, or eta-alumina or mixtures thereof, most preferably eta-alumina. The ingredients are admixed for a mixing time providing completion of the reaction of the nitric acid with the alumina. The mixture is then formed into an intermediate catalyst in an appropriate form and shaped, as required. For example, the mixture may be extruded through die plates to form strands that are cut into pellets. The obtained pellets are then dried and heat treated at appropriate temperatures for a period sufficient to develop an attrition resistant structure with a surface area from about 15 to about 350 m²/g. These pellets, with or without adjustment of their surface area, are then impregnated, preferably with a solution of chromic acid with dissolved zirconium carbonate, magnesium oxide, and an alkali metal compound, added under conditions that produce a good distribution of the promoters on the carrier. The impregnated pellets are then dried at a temperature from about 90° C. to about 180° C. and calcined at a temperature from about 500° C. to about 1100° C. followed by a conditioning treatment in steam and air to fix the structure and initial activity of the catalyst as described, for example, in U.S. Pat. No. 2,399,678 and U.S. Pat. No. 2,956,030, the contents of which are incorporated herein by reference.

Additional promoters, such as scandium, yttrium, lanthanum, titanium, hafnium or combinations thereof, may optionally be added to the dehydrogenation catalyst of the present invention.

The catalysts of the present invention are effective as dehydrogenation catalysts and are especially effective in promoting the dehydrogenation of propane, iso-n-butane and iso-pentane to produce the related olefins or diolefins. Thermodynamic beneficial conditions for this paraffin dehydrogenation reaction are 400-700° C., preferably 540-640° C., and at lower than atmospheric pressure, preferably 0.2-0.5 atmosphere. To provide heat balance, the dehydrogenation process is performed cyclically; dehydrogenation—regeneration, using suitable time intervals. The contact time of the reactant-containing gas with the catalyst is expressed in terms of liquid-hourly-space velocity (LHSV), which is defined as the volume of liquid hydrocarbon reactant per volume of catalyst per hour. The LHSV of the reactant can vary between 0.1 hour⁻¹ and about 5 hours ⁻¹.

To predict catalyst stability, a method of accelerating artificial catalyst aging has been used as is disclosed in “Catalyst and process improvements for increased stability CATOFIN i-C₄ and C₃ dehydrogenation”; A. Rokicki, R. Brummer, and V. Fridman, Süd-Chemie Inc. Louisville, Ky., USA Catalysts in Petroleum Refining and Petrochemicals, Proceeding [of the] Saudi-Japanese Symposium, 11th, Dhahran, Saudi Arabia, Nov. 11-12, 2001 (2001), Meeting date 2001, paper 12/1-paper 12/15.

The aging is carried out at 600-900° C. cyclically. The cycle usually contains reduction-dehydrogenation-oxidation stages with suitable time intervals. Cycle time is from about a few seconds up to 20 minutes. The catalyst is preferably aged for a period of time that is equivalent to about one year of activity of the catalysts on line. To evaluate the stability of the catalysts, besides activity characteristics, the physical-chemical properties of the aged catalysts, such as alpha-(Cr,Al) phase content, and surface area are determined. Alpha-(Cr,Al) content and surface area are indirect indicators of catalyst stability. They show a reduction of surface area and appearance of alpha-(Cr,Al) in catalyst as a result of aging. Decreases in alpha-(Cr,Al) content in the catalysts indicates higher stability of the catalysts.

### EXAMPLES

The following examples illustrate and explain the present invention, but are not to be taken as limiting the present invention in any regard. Parts and percentages are by weight unless otherwise designated. All preparations contain alumina, chromium and sodium oxide. Comparative Examples 1, 2 and 3 describe the preparation of embodiments of prior art catalysts while Example 4 shows the performance of the catalyst of the invention.

### Comparative Example 1

A dehydrogenation catalyst, with a composition of 19.0 wt. % Cr₂O₃, 0.6 wt. % Na₂O and the remaining part alumina is prepared as follows:

Hard alumina pellets are prepared from alumina trihydrate and aqueous nitric acid. The ingredients are thoroughly admixed; the mixing time providing completion of the reaction of nitric acid with the alumina. The mixture is then formed into pellets of ⅛″ diameter. The obtained pellets are dried. The carrier is heat treated at 371° C. in an atmosphere of air and then heat-treated at 616° C. in steam.

The alumina oxide pellets are then impregnated with a solution of a mixture of sufficient amounts of chromium acid and sodium hydroxide to produce the weight percentages for the components listed above. The impregnated alumina oxide is dried several hours at 121° C. and calcined at 770° C. in 20 mol percent steam.

The catalysts are aged in an artificial aging unit with a tubular reactor of 2″ internal diameter. The conditions produce aging of the catalysts that is equivalent to the age of the same catalyst operated in a commercial CATOFIN® process for about twelve month. The conditions of artificial aging are: temperature X (in the range 650-850° C.), cycle time Y minutes (in the range of 0.5-5 minutes), and a total number of the cycles that are sufficient to equate to about one year of activity on line.

### Comparative Example 2

The catalysts of Comparative Example 2 are prepared from hard alumina pellets according to Comparative Example 1. The hard alumina pellets are impregnated with a solution of a mixture of sufficient amounts of chromium acid, sodium hydroxide and magnesium oxide to produce the weight percentages for the components that are listed below. The impregnated alumina pellets are dried several hours at 121° C. and calcined according to the process of Comparative Example 1. The final formulation of the catalyst is Cr₂O₃—19 wt. %, Na₂O—0.6 wt. %, MgO—1.5 wt. %, with the remaining part being Al₂O₃.

### Comparative Example 3

The catalysts of Comparative Example 3 are prepared from hard alumina pellets according to Comparative Example 1. The hard alumina pellets are impregnated with a solution of sufficient amounts of chromium acid, sodium hydroxide and zirconium basic carbonate to produce the weight percentages for the components that are listed below. The impregnated alumina pellets are dried several hours at 121° C. and calcined according to Comparative Example 1. The final composition of the catalyst is Cr₂O₃—19 wt. %, Na₂O—0.6 wt %, ZrO₂—0.7 wt. %, with the remaining part being Al₂O₃.

### Example 4

The catalysts of Example 4 are prepared from hard alumina pellets obtained from Comparative Example 1. The hard alumina pellets are impregnated with a solution of a mixture of sufficient amounts of chromium acid, sodium hydroxide, zirconium basic carbonate and magnesium oxide to produce the weight percentages for the components listed below. The impregnated alumina pellets are dried at 121° C. until LOI is less than 4% and calcined according to the process of Comparative Example 1. The final formulation of the catalyst is Cr₂O₃—19 wt. %, Na₂O—0.6 wt %, ZrO₂—0.7 wt %, MgO—0.75%, with the remaining part of the catalyst being Al₂O₃.

The catalysts of Comparative Examples 1, 2, 3 and Example 4 are artificially aged at the conditions described above. The aged samples are then evaluated for activity after aging and for the physical-chemical characteristics of the catalysts, such as alpha-(Cr,Al) content and surface area.

Table 1 shows the effect of the addition of Zr, Mg and Na as promoters, on the performance of the catalysts according to the invention. The fresh and aged catalysts of all examples were tested for isobutane dehydrogenation performance in an externally heated tubular reactor of 1″ internal diameter. Isobutane was introduced to the catalyst at controlled throughput and pressure (LHSV=1.02 and pressure=0.33 atm.) over a range of temperatures from 537° C. to 621° C. Dehydrogenation products were analyzed to determine conversion (% C) of isobutane, selectivity (% S) to isobutylene, and yield (% Y) of isobutylene.

TABLE 1

| | | | | | | | Physical | |
|---|---|---|---|---|---|---|---|---|
| | | | | | | | Properties of | |
| | | | | | | | Catalysts | |
| | | | | | | | After | |
| | | | | | | | Artificial | |
| | Isobutane | | | | | | Aging | |
| | Dehydrogenation | | | Isobutane | | | | Sur- |
| | On Fresh | | | Dehydrogenation | | | % of | face |
| | Catalysts* | | | After Aging** | | | alpha- | area |
| Example | % C | % S | % Y | % C | % S | % Y | (Cr, Al) | m²/g |
| Comparative | 75.0 | 83.0 | 62.3 | 58.6 | 85.6 | 50.2 | 37 | 32 |
| Example #1 | | | | | | | | |
| Comparative | 75.0 | 85.1 | 63.8 | 60.9 | 88.6 | 54.0 | 30 | 32 |
| Example #2 | | | | | | | | |
| Comparative | 74.4 | 85.0 | 63.2 | 71.5 | 84.2 | 60.2 | 3.8 | 42 |
| Example #3 | | | | | | | | |
| Example #4 | 74.9 | 84.9 | 63.6 | 71.0 | 89.4 | 63.4 | 2.7 | 50 |

*Dehydrogenation temperature −566° C.,
**Dehydrogenation temperature −593° C.

As shown by Table 1, promotion of the catalyst using zirconium and magnesium promoters provides significantly higher selectivity and higher olefin yield after aging than the comparative catalysts.

The catalysts of the present invention are intended for use in stationary and/or fluid bed dehydrogenation processes. The composition of the catalysts and the processing condition may be varied without exceeding the scope of the invention.

1. A catalyst for use in stationary or fluid bed dehydrogenation processes for converting hydrocarbons to olefins and/or diolefins, said catalyst comprising:
a carrier; chromium, in the form of Cr₂O₃, at a concentration from about 10 wt % to about 30 wt %, based on the total catalyst weight, zirconium, as a promoter, in the form of ZrO₂, at a concentration from about 0.1 wt % to about 15 wt % zirconium based on the total catalyst weight, and magnesium, as a promoter, in the form of MgO, at a concentration from about 0.1 wt % to about 15 wt % magnesium, based on the total catalyst weight.

2. The catalyst of claim 1 wherein the carrier is selected from a group consisting of aluminum oxide, alumina, alumina monohydrate, alumina trihydrate, transition alumina, gamma-alumina, delta-alumina, eta-alumina, alumina-silica, silica, silicates, zeolites, bayerite, gibbsite, nordstrandite and combinations thereof.

3. The catalyst of claim 1 wherein the carrier has a surface area of from about 15 m²/g to about 300 m²/g, a pore volume of from about 0.2 cc/g to about 1.5 cc/g, and an average pore diameter of from about 3 nm to about 30 nm.

4. The catalyst of claim 1 wherein the carrier has a particle size of from about 20 μm to about 150 μm.

5. The catalyst of claim 1 wherein the carrier comprises an alumina carrier that is spray-dried or pelletized and calcined at from about 500° C. to about 1100° C.

6. The catalyst of claim 1 wherein the chromium promoter is derived from a member selected from the group consisting of CrO₃, inorganic chromium salts, ammonium chromate, ammonium dichromate, chromium nitrate, organic chromium salts, and combinations thereof.

7. The catalyst of claim 1 wherein the chromium promoter is present in the form of Cr₂O₃ at a concentration from about 15 wt % to about 28 wt %, based on the total catalyst weight.

8. The catalyst of claim 1 wherein the chromium promoter is added in the form of a CrO₃ solution that is impregnated onto the alumina carrier.

9. The catalyst of claim 1 wherein the zirconium promoter is present in the form of ZrO₂ at a concentration of from about 0.1 wt % to about 5 wt %, based on the total catalyst weight.

10. The catalyst of claim 1 wherein the zirconium promoter is present in the form of ZrO₂ at a concentration of from about 0.5 wt % to about 1.5 wt %, based on the total catalyst weight.

11. The catalyst of claim 1 wherein the zirconium promoter is co-impregnated on the carrier with the chromium promoter.

12. The catalyst of claim 1 wherein the magnesium promoter is present in the form of MgO at a concentration from about 0.1 to about 2 wt %, based on the total catalyst weight.

13. The catalyst of claim 1 further comprising from about 0.3 to about 2 wt %, based on the total catalyst weight, of an alkali metal promoter, expressed in the form of an alkali metal oxide.

14. The catalyst of claim 1 further comprising at least one additional promoter selected from the group consisting of scandium, yttrium, lanthanum, titanium, hafnium and combinations thereof.

15. A dehydrogenation catalyst comprising:
a carrier selected from the group consisting of aluminum oxide, alumina, alumina monohydrate, alumina trihydrate, transition alumina, gamma-alumina, delta-alumina, eta-alumina, bayerite, gibbsite, nordstrandite, alumina-silica, silica, silicates, zeolites and combinations thereof, having a surface area from about 15 m²/g to about 300 m²/g, a pore volume from about 0.2 cc/g to about 1.5 cc/g, and an average pore diameter from about 3 nm to about 30 nm;
chromium, as a promoter, calculated as Cr₂O₃, at a concentration from about 15 wt % to about 28 wt %, based on the total catalyst weight, wherein the chromium is derived from a member selected from the group consisting of CrO₃, ammonium chromate, ammonium dichromate, chromium nitrate, organic chromium salts, other inorganic chromium salts, and combinations thereof;
zirconium as a promoter, calculated as ZrO₂, at a concentration from about 0.1 wt % to about 5 wt % zirconium, based on the total catalyst weight; and
magnesium as a promoter, calculated as MgO, at a concentration from about 0.1 to about 2 wt %, based on the total catalyst weight.

16. The catalyst of claim 15 wherein the chromium promoter is present at a concentration from about 17 wt % to about 24 wt %, based on the total catalyst weight.

17. The catalyst of claim 15 wherein the chromium is added in the form of a CrO₃ solution that is impregnated onto the alumina carrier.

18. The catalyst of claim 15 wherein the zirconium promoter in the form of ZrO₂ is present at a concentration from about 0.5 wt % to about 1.5 wt %, based on the total catalyst weight.

19. The catalyst of claim 15 wherein the magnesium promoter in the form of MgO is present at a concentration from about 0.5 to about 1 wt %, based on the total catalyst weight.

20. The catalyst of claim 15 wherein the zirconium is co-impregnated on the carrier with the chromium and the magnesium.

21. The catalyst of claim 15 further comprising from about 0.3 to about 2 wt %, based on the total catalyst weight, of an alkali metal promoter, expressed in the form of an alkali metal oxide.

22. The catalyst of claim 15 further comprising at least one promoter selected from the group consisting of scandium, yttrium, lanthanum, titanium, hafnium and combinations thereof.

23. The catalyst of claim 15 which is used for dehydrogenation in a stationary or fluid bed.

24. A dehydrogenation catalyst comprising:
a carrier selected from the group consisting of aluminum oxide, alumina, alumina monohydrate, alumina trihydrate, transition alumina, gamma-alumina, delta-alumina, eta-alumina, bayerite, gibbsite, nordstrandite, alumina-silica, silica, silicates, zeolites and combinations thereof, and having a surface area from about 15 m²/g to about 300 m²/g, a pore volume from about 0.25 cc/g to about 0.35 cc/g, and an average pore diameter from about 3 nm to about 30 nm, wherein said carrier is spray-dried or pelletized and calcined;
chromium, as a promoter, calculated as Cr₂O₃, at a concentration from about 17 wt % to about 24 wt %, based on the total catalyst weight, wherein said chromium is derived from a member selected from the group consisting of CrO₃, ammonium chromate, ammonium dichromate, chromium nitrate, organic chromium salts, other inorganic chromium salts, and combinations thereof, wherein said chromium is added to the support in the form of a CrO₃ solution that is impregnated onto the carrier;
an alkali metal, as a promoter, calculated as an alkali metal oxide, at a concentration from about 0.3 wt % to about 2 wt %, based on the catalyst weight;
zirconium, as a promoter, calculated as ZrO₂, at a concentration from about 0.5 wt % to about 1.5 wt % zirconium, based on the total catalyst weight; and
magnesium, as a promoter, calculated as MgO, at a concentration from about 0.5 wt % to about 1 wt % magnesium, wherein the magnesium is co-impregnated on the carrier with the chromium and zirconium.

25. The catalyst of claim 24 further comprising at least one promoter selected from the group consisting of scandium, yttrium, lanthanum, titanium, hafnium and combinations thereof.

26. The catalyst of claim 24 which is used for dehydrogenation in a stationary or fluid bed.

27. The catalyst of claim 24 wherein the alkali metal promoter comprises about 0.3 to about 1 wt % Na₂O, based on the total catalyst weight.
